(19) United States
(12) Patent Application Publication
(10) Pub. No.: US 2024/0328199 A1
(43) Pub. Date: Oct. 3, 2024

(54) MONITORING THE LOCKING MECHANISM ON AN ELECTRICAL LOCKING UNIT

(71) Applicant: MEMO Beteiligungs- und Verwaltungs GmbH, Vienna (AT)

(72) Inventor: Harald Czellary, Rabat (MT)

(21) Appl. No.: 18/622,058

(22) Filed: Mar. 29, 2024

(30) Foreign Application Priority Data
Mar. 29, 2023 (AT) A50225/2023

(51) Int. Cl. E05B 47/00; E05B 45/06; E05B 45/12

(52) U.S. Cl. CPC E05B 47/0001; E05B 45/12; E05B 2045/065; E05B 2045/069; E05B 2047/0054; E05B 2047/0069

(57) ABSTRACT

Monitoring a locking mechanism of an electric locking unit includes reversibly adjusting a locking bolt from an open position to a closed position during a closing operation; wherein the locking bolt extends from a recess of a locking part in the open position; and wherein the locking bolt projects into the recess of the locking part in the closed position; determining a closing time span of the locking bolt, wherein the closing time span of the locking bolt comprises an amount of time that the locking bolt requires to transition from the open position to the closed position during the closing process; comparing the determined closing time span of the locking bolt with a predetermined closing time span limit value; and detecting delayed locking of the electric locking unit when the determined closing time span exceeds the predetermined closing time span limit value.

### CROSS REFERENCES

This application claims priority to Austrian Application No. A50225/2023, filed Mar. 29, 2023, the entire disclosure of which is hereby incorporated by reference herein.

### TECHNICAL FIELD

The present disclosure relates to a method for monitoring the locking process or mechanism of an electric locking unit according to Patent claim 1, a locking system according to Patent claim 5, an electric locking unit according to Patent claim 12 and a cabinet according to Patent claim 16.

### BACKGROUND

A wide variety of jigs, equipment or devices such as mechanical locks or electrically actuated latches or locks which can lock the doors of cabinets are known from the state of the art. EP 3029226 A1, for example, discloses an electric locking unit for closing and locking cabinets. The housing of the electric locking unit is fitted in the interior of a cabinet and a locking part is attached to the door of the cabinet. The locking part is attached to the door in such a way that when the door is closed, the locking part protrudes into a recess in the electric locking unit. The door is subsequently locked by means of a locking bolt, which thereby engages in a recess in the locking part when the door is closed.

However, a disadvantage of the known locking units is that when the door is incorrectly adjusted, then the door can be closed but the locking bolt is still blocked by the locking part and cannot reach its closed position, so that the door is closed but remains unlocked. This is highly undesirable, as the items stored in the cabinet are then not stored securely and can be stolen, for example.

In connection with locking doors etc., alarm systems are known from the state of the art, for example, which implement a completion signal of the locking status by monitoring the end contact of an electrical locking mechanism. However, such alarm systems only can determine whether a door is closed or open, for example, but not whether a closed door is also locked.

It is therefore the task of the present disclosure in question to remedy this situation and to therefore provide a method for monitoring the locking of an electric locking unit, as well as an electric locking unit with locking monitoring, which enable reliable monitoring of the locking status of the electric locking unit, in particular when it is arranged on a cabinet or safe, for example.

### SUMMARY

The present disclosure solves this problem in a method for monitoring the locking mechanism in an electric locking unit, in particular for jewelry cabinets,
whereby the electric locking unit comprises a locking bolt which can be inserted into a recess of a locking part, in particular one which can therefore be arranged on a door or drawer of the jewelry cabinet,
whereby the locking bolt can be reversibly adjusted from an open position to a closed position during a closing operation, in particular for the door or drawer of the jewelry cabinet,
whereby the locking bolt is extended from the recess of the locking part in the open position and
whereby the locking bolt protrudes at least partially into the recess of the locking part in the closed position, whereby a locking mechanism can be produced.

According to the present disclosure, the following is provided,
that the closing time span of the locking bolt is determined, whereby the closing time span of the locking bolt is considered to be the time span which the locking bolt requires for the transition from the open position to the closed position during the closing process,
that the determined closing time span of the locking bolt is compared with a predetermined closing time span limit value and
that delayed locking of the electric locking unit is detected when the closing time span limit value has been exceeded.

This embodiment of a method according to the present disclosure makes it advantageously possible to detect, at an early stage, when the closing time span required by the locking bolt during a closing operation, e.g., when closing a door or drawer of a cabinet which has been secured with the electric locking unit, is extended beyond a selected limit value. This is a reliable indication that the locking function of the electric locking unit is impaired or no longer locks correctly.

This closing time span is therefore considered to be the time span that the locking bolt requires with a certain geometric configuration of the electric locking unit to move from the-fully-open position into the recess in the locking part and assume the-fully-closed position, therefore blocking the locking part and locking a door, for example. If this time span is extended beyond the specified closing time span limit value, for example as determined by test trials, then it can be assumed that the locking bolt is no longer moved into the recess in the locking part at all or is no longer moved properly, as can occur when the locking bolt rubs against the locking part.

This closing time span of the locking bolt can be undesirably extended when, for example, the alignment of the locking part relative to the locking bolt is altered, i.e., when, for example, the adjustment of the locking part relative to the locking bolt on the door or drawer of the cabinet alters and the locking bolt rubs against the locking part during the closing process. Even when, for example, the tension of a locking bolt which has been adjusted by a spring between the open and closed position decreases, such an extension of the closing time span of the locking bolt can occur.

This is a gradual problem will will become gets progressively worse over time. This means that initially, for example, the locking bolt will rub a little against the striker and the closing time will be slightly longer, although the locking bolt will still lock the locking unit properly. This can increase to a condition in which the locking bolt rubs heavily against the locking part and the closing time is considerably longer, although the locking bolt still locks the locking unit properly. Finally, however, it can also occur that the locking bolt is blocked by the locking part and the locking bolt no longer moves the recess of the locking part and therefore the locking unit no longer locks at all, which is referred to in the context of the present disclosure as a lack of locking.

In the context of the present disclosure, delayed locking is therefore understood to mean a condition of the electric locking unit in which the closing time span which is currently required by the locking bolt for the transition from the open to the closed position is extended compared to the closing time span when the locking part is correctly adjusted and/or aligned relative to the locking bolt respectively, but the locking bolt still locks correctly.

Further explanations of how the closing time of the locking bolt is extended are provided in connection with the description of an embodiment example, although they are generally valid for all conceivable embodiments of the present disclosure.

This embodiment of a method according to the present disclosure makes it possible, for example, to reliably detect at an early stage that the electric locking unit is locking with a delay when doors or drawers equipped with an electric locking unit are incorrectly adjusted. Such reliable detection of delayed locking prevents theft and is also useful for keeping repair costs low and executing preventive maintenance, for example.

For particularly precise determination of the closing time span which is required by the locking bolt for the transition from the open to the closed position, it can be provided that the open position and the closed position of the locking bolt are monitored, whereby:
those points in time are determined at which the locking bolt assumes the open position, and
the times at which the locking bolt assumes the closed position are determined.

In order to be able to detect a lack of, i.e., no locking of the electric locking unit in cases in which, for example, the locking bolt is completely defective and can no longer be moved out of the open position, or is blocked in its movement into the closed position and no longer assumes the closed position, it can be provided that a closing time span maximum value is predetermined in advance, whereby the closing time span maximum value is considered as the maximum time span of the electric locking unit. In order to be able to determine that the electric locking unit is not locked, i.e., not locked at all, it may be provided that a maximum closing time span value is specified in advance, whereby the maximum closing time span value specifies the maximum time span for reaching the closed position of the locking bolt after reaching the open position of the locking bolt has been determined and
that a lack of locking of the electric locking unit is detected when the period of time which has elapsed since it was determined that the locking bolt assumes the open position exceeds the maximum closing time span value and it has not yet been determined that the locking bolt assumes the closed position.

If, after it has been determined that the locking bolt is located in the open position, a period of time has elapsed that is longer than the specified maximum closing time span value, then a failure to lock the electric locking unit is advantageously detected automatically.

Particularly detailed information about an incipient extension of the closing time span of the locking bolt, for example when triggered by any rubbing of the locking bolt against the locking part, can be collected when the closing speed of the locking bolt is measured based on:
the determined times at which the locking bolt assumes the open position,
the determined times at which the locking bolt assumes the closed position, and
the known distance to be covered by the locking bolt between the open and closed position is determined.

According to a particularly advantageous variant of one method according to the present disclosure, an electric locking unit can be provided which, on the one hand, reliably opens and closes a cabinet and, on the other hand, automatically secures the closed door of the cabinet in the deenergized condition and reliably enables locking even in the deenergized condition,
that the locking part of the electric locking unit can be inserted into a closing recess of the electric locking unit and can therefore be brought into an adjustment path of the locking bolt during the closing process,
that during the closing process, the locking part is introduced into the closing recess and strikes the locking bolt, so that the locking bolt subsequently moves against the spring force of a spring and the spring is tensioned and the firing bolt is displaced into the open position and clears the way for the locking part into the closing recess, and
that as soon as the recess of the locking part comes into the adjustment path of the locking bolt, the locking bolt is therefore extended again by the spring force of the spring and pressed into the recess of the locking part and retained there in the closed position, so that the locking bolt engages in the recess and blocks the locking part from exiting the locking recess.

The task of the present disclosure is also to provide a locking system which enables effective and reliable monitoring of the locking mechanism in an electric locking unit, in particular for jewelry cabinets.

Embodiments of the present disclosure solves this problem with a locking system comprising:
an electric locking unit comprising a locking bolt that can be inserted into a recess in a locking part,
whereby the locking bolt can be reversibly adjusted from an open position to a closed position during a closing operation,
whereby the locking bolt is extended from the recess of the locking part in the open position and
whereby the locking bolt projects into the recess of the locking part in the closed position, whereby a locking mechanism can be produced and
a control unit connected to the electric locking unit and/or in data communication, which is designed to implement a method according to the present disclosure for monitoring the locking in an electric locking unit.

Such a monitoring system with a control unit which has been designed according to the present disclosure can be utilized in order to exploit all the aforementioned advantages of a method according to the present disclosure.

A particularly simple and reliable way of monitoring the open and closed position of the locking bolt while maintaining a compact design can be achieved in an electric locking unit and/or locking system according to the present disclosure when the electric locking unit
for monitoring the open position is equipped with a first electrical switch which is interrupted in its initial state, whereby an electrically conductive connection can be established and the first switch can be closed when the locking bolt assumes the open position and
indicates a second electrical switch, which is interrupted in its initial state, for monitoring the closed position, whereby an electrically conductive connection can be established and the second switch can be closed when the locking bolt assumes the closed position,
whereby the electrical switches are connected to the control unit and that the control unit is designed for this purpose,
to determine those times at which the first electrical switch is closed at the open position as those times at which the locking bolt assumes the open position and
the times at which the second electrical switch is closed in the closed position are determined as the times at which the locking bolt assumes the closed position.

A particularly compact design of the switches with a simultaneously reliable detection function can be achieved in this context when the first electrical switch and the second electrical switch are each formed by an open pair of electrodes, with the open pair of electrodes each being designed in such a way that current flows between the two electrodes of the open pair of electrodes when the locking bolt assumes the open position and when the locking bolt assumes the closed position.

According to an alternative embodiment of an electric locking unit or locking system according to the present disclosure, also with a particularly compact design of the switches and a reliable detection function at the same time, it can be provided that the electric locking unit
indicates a first mechanically actuable switch for monitoring the open position, the first mechanically actuable switch being designed and arranged in such a way that it can be actuated when the locking bolt is moved into the open position, in particular by a control pin which has been arranged on the locking bolt, it preferably being provided that the first mechanically actuable switch is designed to emit a corresponding electrical signal when actuated and
indicates a second mechanically actuable switch for monitoring the closed position, the second mechanically actuable switch being designed and arranged in such a way that the second mechanically actuable switch can be actuated when the locking bolt is moved into the closed position, in particular by the control pin of the locking bolt, it being preferably provided that the second mechanically actuable switch is designed to emit a corresponding electrical signal when actuated,
whereby the mechanically operable switches are connected to the control unit and that the control unit is designed for this purpose,
to determine in each case those times of actuation of the first mechanically actuable switch at the open position as those times at which the locking bolt assumes the open position and
the times at which the second mechanically actuable switch is actuated in the closed position are determined as the times at which the locking bolt assumes the closed position.

In order to be able to reliably detect cases in which the locking bolt no longer assumes the closed position and the electric locking unit remains unlocked, it can be provided that a closing time span maximum value is therefore stored in the control unit, whereby the closing time span maximum value specifies the maximum time span for reaching the closed position of the locking bolt after reaching the open position of the locking bolt has been determined, and the closing time span maximum value specifies the maximum time span for reaching the open position of the locking bolt after reaching the closed position of the locking bolt has been determined and that the control unit is designed in such a way to be able to detect a lack of locking of the electric locking unit when the period of time which has elapsed since it was determined that the locking bolt assumes the open position exceeds the maximum closing period value and it has not yet been determined that the locking bolt assumes the closed position.

In order to draw the attention of operating personnel to an incipient extension of the closing period and/or a lack of locking of the electric locking unit, it can be provided that the control unit is designed to emit a warning signal, in particular an optical and/or acoustic signal, when a delayed locking of the electric locking unit is detected and/or when a lack of locking of the electric locking unit is detected.

In order to also be able to transmit information to, for example, the manufacturer of the electric locking unit or a security service, it can advantageously be provided that the locking system comprises a communication unit, whereby the communication unit is connected downstream of the control unit and is therefore designed to transmit information which has been determined by the control unit, in particular information about delayed locking and/or missing locking of the electric locking unit, to a server.

According to a particularly advantageous variant of a locking system according to the present disclosure and/or an electric locking unit according to the present disclosure for a locking system according to the present disclosure, which on the one hand enable reliable opening and closing of a cabinet and on the other hand automatically secure the closed door of the cabinet in the deenergized condition and reliably enable locking even in the deenergized condition, it can be provided that
the locking part of the electric locking unit can be inserted into a closing recess of the electric locking unit and can therefore be brought into an adjustment path of the locking bolt during a closing process,
that during the closing process, the locking part can be introduced into the closing recess so that it impinges on the locking bolt, so that the locking bolt moves against the spring force of a spring and the spring is tensioned and the firing bolt is displaced into the open position and clears the way for the locking part into the closing reces, and
that as soon as the recess of the locking part comes into the adjustment path of the locking bolt, then the locking bolt can be extended again by the spring force of the spring and pressed into the recess of the locking part and retained there in the closed position, so that the locking bolt engages in the recess and blocks the locking part from exiting the locking recess.

The present disclosure additionally relates to a cabinet, in particular a safe cabinet, with a minimum of one door and an interior space delimited by the door, which indicates the presence of an electrical locking unit according to the present disclosure, whereby it is provided in particular that the electrical locking unit is arranged in the interior space of the cabinet and the locking part is arranged on the door of the cabinet, whereby in an open state of the electrical locking unit, the locking part is extended from the electrical locking unit and the door can be opened.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a perspective view of an electric locking unit according to the present disclosure in the locked state, i.e., with the locking bolt in the closed position.

FIG. 2 is a side view of the electric locking unit from FIG. 1 in the locked state, i.e., with the locking bolt in the closed position.

FIG. 3 is a side view of the electric locking unit from FIG. 1 with the locking bolt in the half-closed position.

FIG. 4 is a side view of the electric locking unit from FIG. 1 in the unlocked state, i.e., with the locking bolt in the open position.

FIG. 5a is a top view of the locking part and the locking bolt of the electric locking unit from FIG. 1 when correctly locked with the locking bolt and the locking part in a correctly adjusted state relative to each other.

FIG. 5b a top view of the electric locking unit from FIG. 1 with the locking bolt and the locking part correctly adjusted in relation to each other when properly locked.

FIG. 6a a top view of the locking part, as well as the locking bolt of the electric locking unit from FIG. 1, with the locking bolt beginning to rub against the locking part and the closing time span slightly extended.

FIG. 6b a top view of the electric locking unit from FIG. 1 with the locking bolt beginning to rub against the locking part and the closing time span slightly extended.

FIG. 7a a top view of the locking part and the locking bolt of the electric locking unit from FIG. 1 with strong friction of the locking bolt on the locking part and a greatly extended closing time span.

FIG. 7b a side view of the electric locking unit from FIG. 1 with strong friction of the locking bolt on the locking part and greatly extended closing time span.

FIG. 8 an example of a locking system according to the present disclosure.

FIG. 9 a sectional view of the electric locking unit from FIG. 1 in the unlocked condition with the locking bolt in the open position.

FIG. 10 a sectional view of the electric locking unit from FIG. 1 in the locked condition with the locking bolt in the closed position.

FIGS. 11 and 12 show a sectional view in the closed condition.

FIGS. 13 and 14 show a sectional view in the open condition.

FIGS. 15 and 16 show a sectional view in the free condition.

FIGS. 17 to 21 show views of an embodiment of a baffle plate.

FIGS. 22 and 23 show a sectional view of an additional embodiment in the closed condition.

FIGS. 24 and 25 show a sectional view of a subsequent embodiment in the open condition.

FIGS. 26 and 27 show a sectional view of a further embodiment in the free condition.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

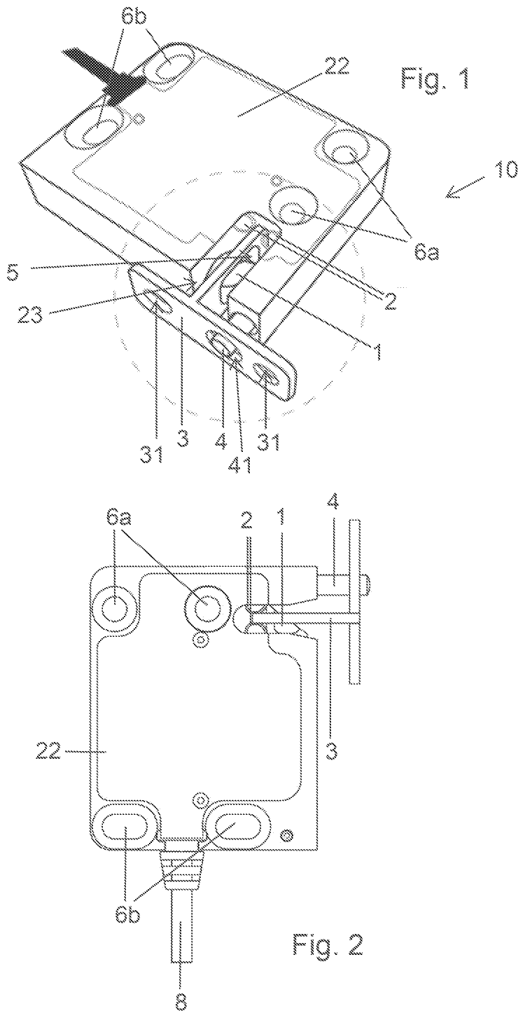

The citation of references herein does not constitute an admission that those references are prior art or have any relevance to the patentability of the technology disclosed herein. All references cited in the “Detailed Description” section of this specification are hereby incorporated by reference in their entirety FIG. 1 when correctly locked with the locking bolt and the locking part in a correctly adjusted state relative to each other,

FIG. 1 shows a perspective view of an electric locking unit 10 of a locking system 100 according to the present disclosure. In the embodiment example, the electric locking unit 10 is utilized in order to close and lock a cabinet in which valuable objects are stored, such as a jeweler's cabinet.

The electric locking unit 10 comprises a housing 22 and a locking part 3, which is designed as an L-shaped profile part in the embodiment which is represented in FIG. 1. The locking part 3 indicates a centrally arranged recess 5 at its short end. Alternatively, the locking part 3 can also be T-shaped in order to achieve better load distribution. The housing 22 is rectangular in shape and indicates a rectangular closing recess 23 on one of its long sides.

The housing 22 of the electric locking unit 10 is fitted inside the cabinet. The housing 22 is attached to the body of the cabinet and screwed to a side wall of the cabinet, for example, via drill holes. In the embodiment example, the drill holes are therefore round fixing holes 6a and adjustable fixing holes 6b. The locking part 3 is attached to the door of the cabinet and screwed to the holes 31 located on the door. The locking part 3 is fastened to the door in such a way that when the door is closed, the locking part 3 is inserted into the locking recess 23 of the electric locking unit 10 and can therefore be inserted into the adjustment path of the locking bolt 1 (see schematic diagram in FIGS. 2 to 4).

The housing 22 is also penetrated by a through-hole, not shown, which is provided on a narrow side. The through-hole extends from this narrow side of the housing to the locking recess 23 and opens vertically into the locking recess 23. A locking bolt 1, for example cylindrical, is inserted into the through-hole. In the embodiment example, a spring 6 is supported at one end in the locking bolt 1 and at the other end on a housing cover of the housing 22.

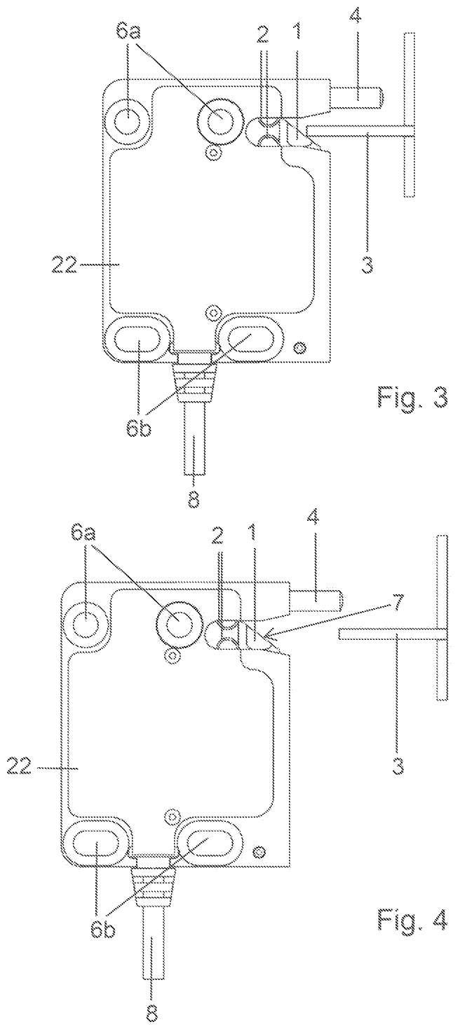

If, during a closing operation, i.e., when the door of the cabinet is closed and the locking part 3 is inserted into the closing recess 23, then the locking part 3 will come into contact with the locking bolt 1 or a chamfer 7 of the locking bolt 1 (see FIG. 3) and will thereby exert a compressive force on it, the locking bolt 1 is moved against the spring force of the spring 6 and the spring 6 is tensioned. The locking bolt 1 is moved into the open position and enables the locking part 3 to move into the closing recess 23.

As soon as the recess 5 of the locking part 3 comes into the adjustment path of the locking bolt 1, the locking bolt 1 is subsequently extended again by the spring force of the spring 6 and pressed into the recess 5 of the locking part 3 and retained there in this condition, in the closed position (see FIG. 2). The locking bolt 1 engages in the recess 5, blocks the locking part 3 from exiting the locking recess 23 and therefore locks the electric locking unit 10.

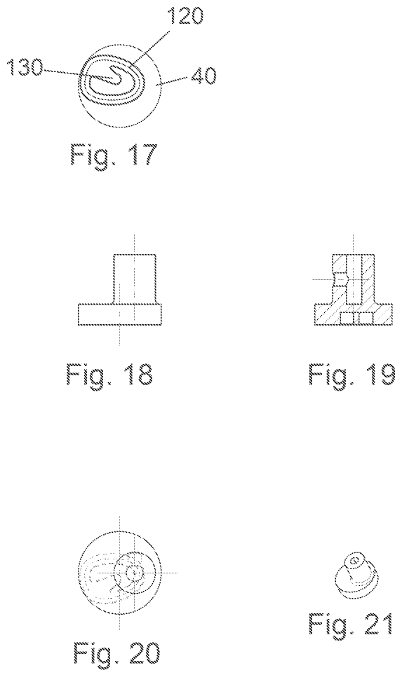

In the embodiment example, the electric locking unit 10 also comprises a drive unit, namely an electric motor and an adjustment unit. The adjustment unit is designed as a splitter disk 40 (see FIGS. 17 to 21) and sits on the shaft of the electric motor. The splitter disk 40 is arranged eccentrically on the shaft of the electric motor and is shaped as a circular disk. A cam track 120 is formed on the splitter disk 40 (see FIGS. 11, 13, 15 and 17). The cam track 120 is formed as a recess and creates a closed and elliptical groove track. When the baffle plate 40 is rotated by the drive unit, then the cam track 120 enables the locking bolt 1 to be adjusted along its axis. The locking bolt 1 comprises an extension 110 on its circumference, which projects into the cam track 120 formed as a recess. The diameter of the extension 110 is slightly smaller than the width of the cam track 120 so that the extension 110 can slide in the cam track 120. The shape of the cam track 120 enables the locking bolt 1 to be adjusted by turning the cam disk 40 into the closed and open condition, as well as a free condition. The extension 110 is brought into alignment along the cam track 120 with three Points A, B and C which are arranged on the cam track 120. Points A and B have the greatest distance on the cam track 120 and mark the maximum opening and the maximum closed condition of the locking bolt 1 or the electric locking unit 100.

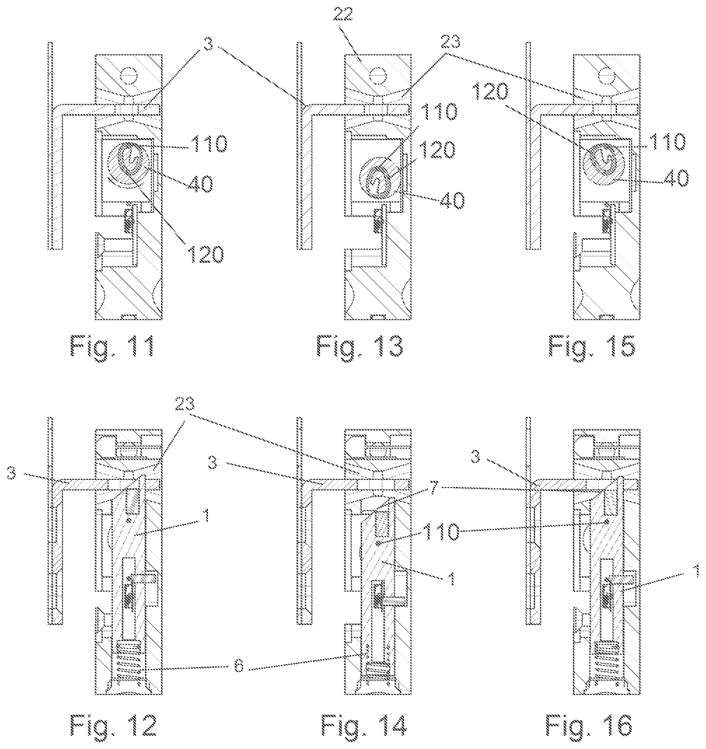

In the closed condition (see FIGS. 11 and 12), the extension 110 of the locking bolt 1 is aligned with Point A. The extension 110 of the locking bolt 1 is held in the extended position by the cam disk 40, as the cam track 120 fixes the extension 110 in this position by supporting it on the wall of the cam track 120 of the cam disk 40.

In the open condition (see FIGS. 13 and 14), the locking bolt 1 is located in the open, retracted, rear condition and is maximally extended from the recess 5 of the locking part 3. The extension 110 blocks additional displacement of the locking bolt 1 along its axis by supporting the extension 110 on the wall of the cam track 120 of the baffle plate 40. The locking part 3 is released and can be removed from the closing recess 23.

In the free condition (see FIGS. 15 and 16), the extension 110 is aligned with Point C. In this position, the baffle plate 4 has a freewheel recess 130 running along the axis of the locking bolt 1. The freewheel recess 130 extends from Point C parallel to the axis of the locking bolt 1 in the direction of the pivot point or center of the cam plate 40. The width of the freewheel recess 130 corresponds at least to the width of the cam track 120, so that the extension 110 can slide along in the freewheel recess 130 and the locking bolt 1 can therefore be moved freely. The length of the freewheel recess 130 corresponds to at least the minimum displacement movement of the locking bolt 1, i.e., the adjustment path of the locking bolt 1 along its axis that is required to fully extend out of the recess 5 of the locking part 3. In the free condition, the locking bolt 1 can therefore be freely adjusted along its axis independently of the rotational movement of the baffle plate 40.

In the free condition of the locking bolt 1, the locking part 3 can be reinserted into the locking recess 23, for example after it has been removed from the latter. The locking part 3 therefore strikes the chamfer 7 of the locking bolt 1 and exerts a compressive force on it, whereby the locking bolt 1 is moved against the spring force of the spring 6 and the spring 6 is tensioned. The extension 110 of the locking bolt 1 plunges into the freewheel recess 130 and the locking bolt 1 allows the locking part 3 to move into the closing recess 23. As soon as the recess 5 of the striker 3 comes into the adjustment path of the striker 1, the striker 1 is extended again by the spring force of the spring 6 and pressed into the recess 5 of the striker 3 and held in this condition, the closed condition. The locking part 3 can therefore not be removed again from the electric locking unit 10 or the locking recess 23 and the electric locking unit 10 is automatically locked again and the locking bolt 1 is in the free condition. The electric locking unit 10 can therefore be locked by the spring 6 even without actuation of the baffle plate 40, for example in the event of a power failure or manipulation of the locking mechanism, and can then only be opened again when the control unit has been actuated and the adjustment is implemented for the open condition.

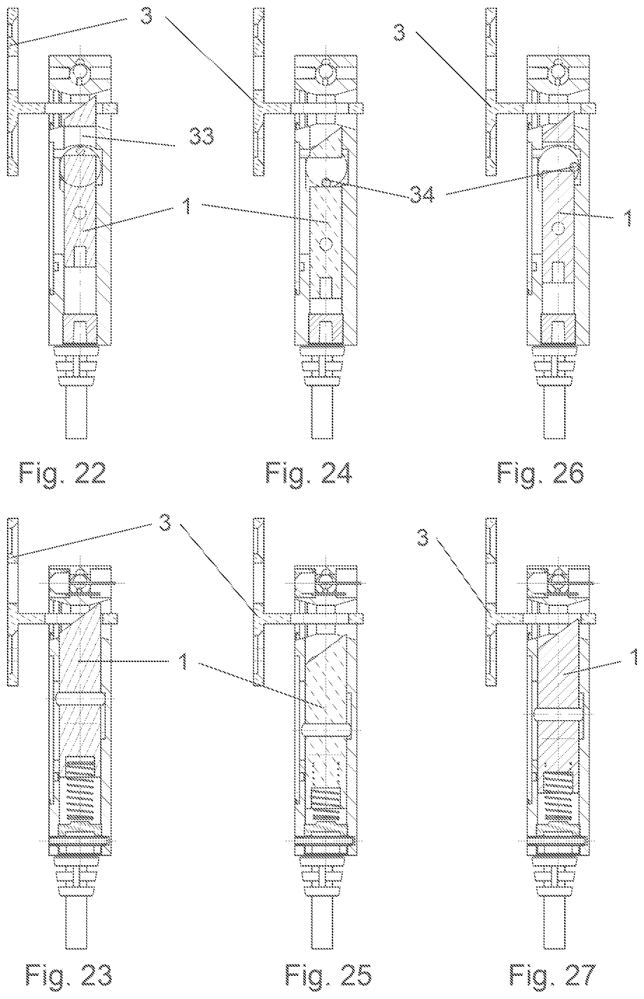

FIGS. 22 to 27 show a further embodiment of the electric locking unit 10 according to the present disclosure. The locking bolt 1 hereby indicates a recess 33. The recess 33 is arranged on the circumferential section facing the splitter disk 4. In this embodiment, the splitter disk 4 indicates an eccentric bolt 34, which projects into the recess 33 of the locking bolt 1. FIGS. 22 and 23 show the electric locking unit 10 in the closed condition. The eccentric bolt 34 lies in the axis of the locking bolt 1 and has the smallest possible distance to the locking opening 5. The locking bolt 1 is pressed into the recess 5 of the locking part 3 by the spring 6, whereby the extension path is limited by the eccentric bolt 34 and the size of the recess 33 of the locking bolt 1.

FIGS. 24 and 25 show the electric locking unit 10 in the open condition. The baffle plate is rotated by 180° around its own axis in relation to the closed condition. The eccentric bolt 34 is located at the maximum distance from the recess 5 of the locking part 3.

FIGS. 26 and 27 show the electric locking unit 10 in the open condition. The baffle plate 4 is rotated by 90° degrees to the open or closed condition, the eccentric bolt 34 is in an intermediate position.

FIG. 2 shows a side view of the electric locking unit 10 in the locked condition. The locking bolt 1 is positioned in the foremost, closed position and is fully extended. The locking bolt 1 is inserted in the recess 5 of the locking part 3 and blocks it so that the locking part 3 is prevented from exiting the electric locking unit 10. If an attempt is now made to open the door, i.e., when an attempt is made to remove the locking part 3 from the locking recess 23, then this will be blocked by the locking bolt 1 and the locking bolt 1 therefore prevents the door from opening. The electric locking unit 10 is locked correctly in this case.

In the embodiment example of an electric locking unit 10 according to the present disclosure shown in FIG. 1, the locking part 3 is additionally held in the closing recess 23 by a spring 31, although this is optional. The spring is designed as a pincer with two opposing pincer arms 2. The pincer arms 2 indicate a spiral shape and consist of a spring wire. The pincer arms 2 embrace the locking part 3 at the end which is inserted into the closing recess 23 and clamp it, whereby the locking part 3 is held in the closing recess 23.

In the open position, the locking bolt 1 is located in its retracted, rear position and is extended from the recess 5 of the locking part 3. The locking part 3 is released and can be removed from the locking recess 23 or inserted further into the locking recess 23.

It can be assumed that when an electric locking unit 10 and/or a locking system 100 according to the present disclosure is put into operation, all adjustments are made correctly, so that the locking bolt 1 is moved at a known closing speed for the respective geometric configuration of the electric locking unit 10 and a known closing time span between the open position, in which the locking part 3 can be freely inserted into the locking recess 23, and the closed position, in which the locking bolt 1 projects into the recess 5 of the locking part 3 or locks it.

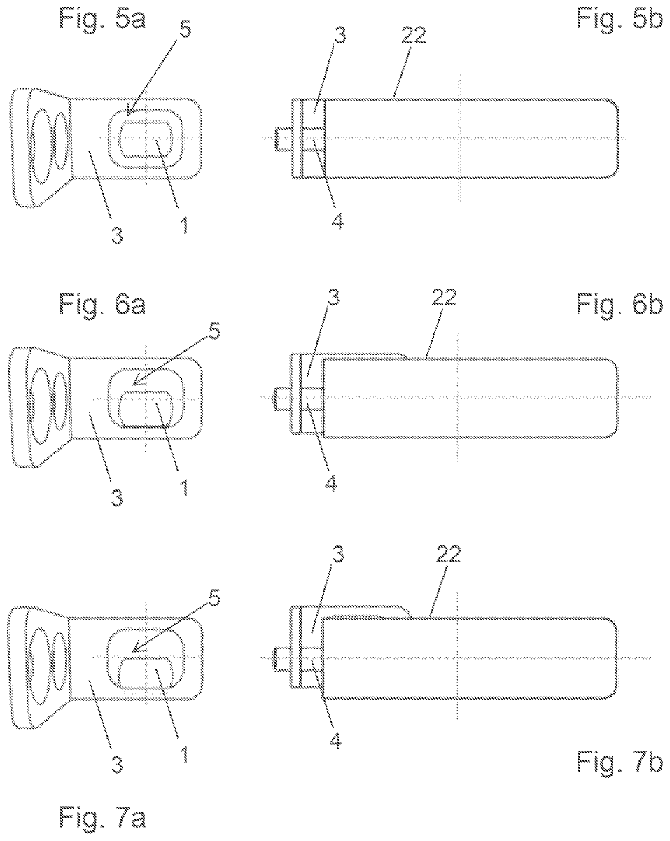

FIGS. 5a and 5b show the alignment of the locking part 3 and the locking bolt 1 and/or the alignment of the locking part 3 and the housing 22 of the electric locking unit 10 to each other when correctly adjusted and properly locked. The center of gravity of the cross-sectional area of the recess 5 of the locking part 3 and the center of gravity of the cross-sectional area of the locking bolt 1 are congruent (see FIG. 5a).

In the course of operation, experience has indicated that there is a more or less slow adjustment and misalignment of the locking part 3 which is mounted on the door of the cabinet from its original, correctly adjusted ideal position to an unacceptable position in which the electric locking unit 10 no longer locks properly. Locking is executed correctly as long as the locking bolt 1 is not completely blocked in its adjustment movement and can be moved into the recess 5 of the locking part 3 at approximately normal speed.

With increasing misalignment of the locking part 3 relative to the locking bolt 1, the locking bolt 1 begins to rub and chafe against the edge of the recess 5 of the locking part 3, and the closing speed subsequently slows down or the closing time span increases. However, the locking mechanism still functions as shown in FIGS. 6a and 6b. The center of gravity of the cross-sectional area of the recess 5 of the locking part 3 is offset relative to the center of gravity of the cross-sectional area of the locking bolt 1 in the direction of the edge of the recess 5 (see FIG. 6a).

If these alterations continue to be permitted, then a point will be reached at which the locking bolt 1 can no longer be moved into the recess 5 of the locking part 3 and locking is no longer possible, as shown in FIGS. 7a and 7b. The center of gravity of the cross-sectional area of the recess 5 of the locking part 3 is thereby shifted so far in the direction of the edge of the recess 5, relative to the center of gravity of the cross-sectional area of the locking bolt 1, that a significant part of the cross-sectional area of the locking bolt 1 comes to lie below the locking part 3 and abuts against the locking part 3 (see FIG. 7a). The locking bolt 1 is blocked by the striker 3 and can no longer be moved into the recess 5. However, this condition is often not visible to the operating personnel, especially when no regular controls are implemented in order to ensure that the lock is correctly locked.

This is where a method according to the present disclosure comes in to ist own and provides a remedy, as the closing time span which the locking bolt 1 requires for the transition from the open position to the closed position, in which the locking bolt 1 is inserted into the recess 5 and locked, is monitored.

As soon as a misalignment and/or misadjustment of the door or the locking part 3 relative to the locking bolt 1 occurs, in which the locking bolt 1 rubs or rubs against the edge of the recess 5, then the closing time span becomes longer and the closing speed of the locking bolt 1 is reduced. A closing time span limit value is determined in test trials and stored in a control unit 20 of the locking system 100. The currently determined closing time span of the locking bolt 1 is compared with the closing time span limit value. If the currently determined closing time span of the locking bolt 1 exceeds the closing time span limit value, then the control unit 20 will detect delayed locking of the electric locking unit 10.

The closing time span limit value therefore specifies a time span which is deemed to be longer than the time span that the locking bolt 1 requires for the adjustment from the open position to the closed position with the respective geometric design of the electric locking unit and correct adjustment of the locking part 3 when compared to the locking bolt 1 and which therefore, depending on the definition of the time span, hereby characterizes an incipient or also advanced rubbing of the locking bolt 1 on the locking part 3.

Based on test trials, the closing time span limit value can be selected in such a way that the electric locking unit 10 is still correctly locked, even though a misalignment of the locking part 3 relative to the locking bolt 1 is already apparent, i.e., an incipient extension of the closing time span of the locking bolt 1 has been detected.

If such an incipient extension of the closing time span of the locking bolt 1 has been detected, then the locking bolt 1 will still lock correctly, although it becomes apparent that the electric locking unit 10 will not lock anymore in the foreseeable future. Early detection of such an incipient extension of the locking period is therefore particularly advantageous in order to be able to execute servicing, maintenance and/or repair work in good time and therefore effectively prevent a lack of locking with the associated safety risks from occurring in the first place.

In the embodiment example of a method according to the present disclosure, a corresponding signal is therefore generated by the control unit 20 as soon as the closing speed is reduced, i.e., the closing time span is therefore extended, and an optical or acoustic warning signal is also emitted in order to draw the operator's attention to the defect, fault and/or or delay which has arisen and thereby to trigger necessary servicing or maintenance work. For this purpose, a locking system 100 according to the present disclosure can also comprise a loudspeaker and/or a light source.

If no servicing, maintenance or repair is executed when the closing time span begins to be extended, whereby the locking part 3 is correctly adjusted again relative to the locking bolt 1, then it can occur, as described above, that the locking bolt 1 can no longer engage in the recess 5 and the electric locking unit 10 still remains unlocked. Therefore, in the embodiment example, an additional time span, namely a maximum closing time span value, will be stored in the control unit 20.

The maximum closing time span value can also be determined experimentally in test trials and thereby specifies a maximum time span after reaching the open position in which the locking bolt 1 should have reached the closed position-even with advanced grinding and/or rubbing on the locking part 3. If this closing time span maximum value and/or this maximum time span is exceeded and it has still not been determined by the control unit 20 that the locking bolt 1 has reached the closed position, then it can be assumed that the electric locking unit 10 is no longer locked, as the locking bolt 1 strikes against the locking part 3 and can therefore no longer be moved into the recess 5. In this case, the control unit 20 will subsequently generate a corresponding signal and emits an optical or acoustic warning signal in order to alert the operator that the lock is not properly locked and that a risk of theft now exists.

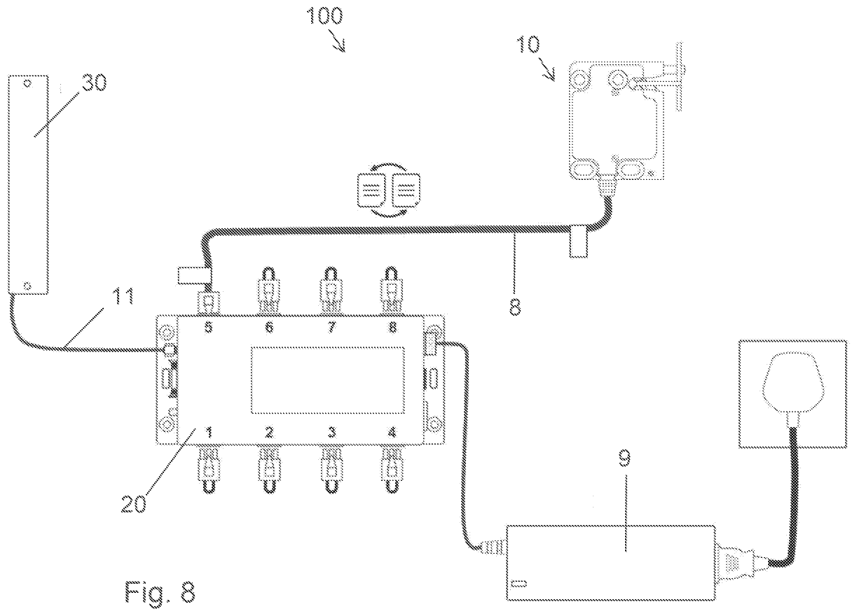

In the embodiment example of a locking system 100 according to the present disclosure in FIG. 8, the electric locking unit 10 is also equipped with a circuit board and a cable 8, that is connected to the circuit board and which is connected to the control unit 20. The circuit board is supplied with power via the cable 8 and exchanges data with the control unit 20 via the cable 8. However, the data exchange between the circuit board and the control unit 20 can of course also take place wirelessly, e.g., via a Bluetooth or WLAN connection. The control unit 20 is connected to a power supply unit 9. The control unit 20 is also connected via a data cable 11 to a memory 30, in which, for example, the closing time span limit value and/or the closing time span maximum value can be stored and, if necessary, data or information which has been determined by the control unit 20 can be stored respectively.

In the following, the mode of operation of an advantageous embodiment of the electric locking unit 10 is described by way of example with reference to the technical drawings:

The electric locking unit 10 is located in the closed condition, as shown in FIGS. 11 and 12. The extension 110 is in alignment with Point A and the extension 110 is locked by the wall thickness of the cam track 120, as a result of which the locking bolt 1 cannot be adjusted. The locking bolt 1 is located in the maximally extended condition and is inserted into the recess 5 of the locking part 3. If an attempt is now made to open the door, i.e., if an attempt is made to move the locking part 3 out of the closing recess 23, then the locking bolt 1 will block this action and therefore prevents the door from opening.

If the user transmits a signal to the circuit board via a switch or a remote control, then the circuit board will control the electric motor in the open condition (FIGS. 13 and 14). The electric motor rotates the baffle plate 40, in this embodiment clockwise, until the extension 110 is brought into alignment with Point B. The extension 110 is moved parallel to the axis of the locking bolt 1 and the locking bolt 1 is therefore guided into the rear open position, the open condition, and is then located in the open condition. The locking bolt 1 is fully extended from the recess 5 of the locking part 3 and the spring 6 is tensioned. A spring with pincer arms 2 (FIG. 3) still retains the locking part 3 in the closed condition. If the door is now opened with the locking part 3 attached to it, then the locking part 3 will emerge from the closing opening 23 and the door is open. A signal is now sent to the circuit board, which carries a switching unit, and the electric motor moves the baffle plate 40 into the free condition. The extension 110 is brought into alignment with Point C and the locking bolt 1 is pushed into the closed position by the spring 6. (FIG. 15, FIG. 16)

If the locking part 3 is now reinserted into the closing recess 23, i.e., the door is closed, then the locking part 3 will strike the chamfer 7, presses the locking bolt 1 into the open position against the spring force of the spring 6 and the locking bolt 1 will subsequently, and completely, clear the way for the locking part 3 into the closing recess 23. As soon as the locking part 3 is inserted into the closing recess 23, then the recess 5 will be brought into the adjustment path of locking bolt 1 and this extends again due to the spring force of the spring 6. The spring 6 displaces the locking bolt 1 into the recess 5 and blocks the locking part 3 from exiting the electric locking unit 10 again. The switching unit of the circuit board sends a control command to the electric motor and the electric motor turns the baffle plate 40 back into the closed condition, the extension 110 is brought into alignment with point A and the locking bolt 1 blocks and fixes the locking part 3 until the circuit board gives the signal to open again.

The open and closed status can be detected, for example, by means of a magnet on the door and a magnetic detector. However, the circuit board or the electric motor can also be actuated by a signal from a switch.

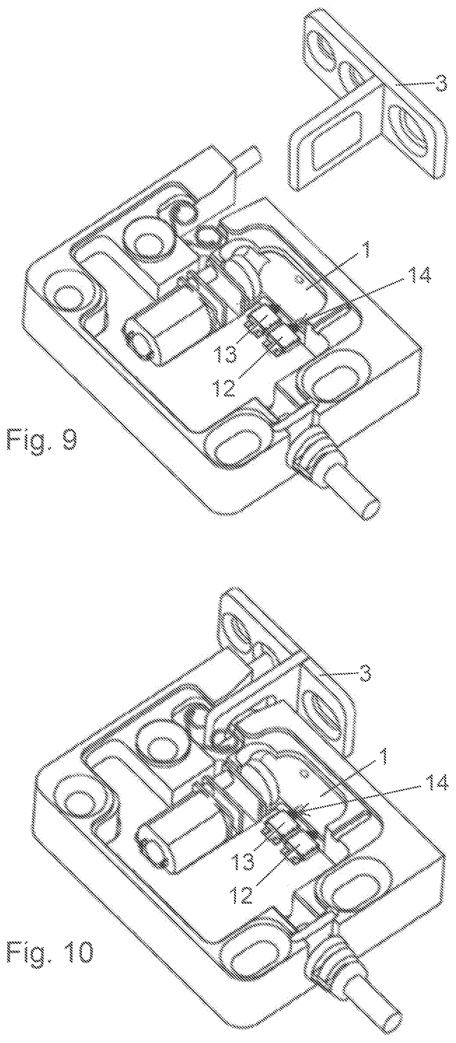

In order to be able to precisely determine the current closing time span of the locking bolt 1, a mechanically actuated switch 12, 13 is provided in the embodiment example for monitoring the open position and the closed position of the locking bolt 1 (see FIG. 9 and FIG. 10), which is mechanically actuated when the locking bolt 1 has been moved into the open position and/or into the closed position and, in this particular case, emits a corresponding signal to the circuit board, which is then forwarded to the control unit 20.

If the locking bolt 1 assumes the open position and/or if the locking bolt 1 is moved to the open position (FIG. 9), then the first mechanically actuable switch 12 will be mechanically actuated by a control pin 14, which is attached to the locking bolt 1, when the control pin slides past the first mechanically actuable switch 12. If the locking bolt 1 assumes the closed position and/or if the locking bolt 1 is moved to the closed position (FIG. 10), then the second mechanically actuable switch 13 will also be mechanically actuated by the control pin 14 when the control pin slides past the second mechanically actuable switch 13.

The two mechanically actuatable switches 12, 13 are each connected to the control unit 20 via the circuit board and the cable 8, and the control unit 20 thereby determines those points in time at which the first mechanically actuatable switch 12 is actuated at the open position as those points in time at which the locking bolt 1 assumes the open position, and those points in time at which the second mechanically actuatable switch 13 is actuated at the closed position as those points in time at which the locking bolt 1 assumes the closed position. Based on these two points in time, the control unit 20 can thereby precisely calculate the current closing time of the locking bolt 1 for a comparison with the closing time limit value and/or the closing time maximum value.

Alternatively, instead of in the case with the mechanical switches for monitoring the open and closed positions, a first and a second electrical switch, each interrupted in its initial condition, can be arranged on the circuit board. If the locking bolt 1 assumes the open position, an electrically conductive connection is established and the first electrical switch is closed. If the locking bolt 1 assumes the closed position, then an electrically conductive connection will be established and the second electrical switch is subsequently closed.

In such an embodiment of the switches, the control unit 20 determines those points in time at which the first electrical switch is closed at the open position as those points in time at which the locking bolt 1 assumes the open position, and those points in time at which the second electrical switch is closed at the closed position as those points in time at which the locking bolt 1 assumes the closed position.

The electrical switches can, for example, each be considered as an open pair of electrodes. Current flows between the two electrodes of the open electrode pair when the locking bolt 1 assumes the open position and when the locking bolt 1 assumes the closed position and an electrical signal is issued by the circuit board and then forwarded on to the control unit 20.

Optionally, a locking system 100 according to the present disclosure can also indicate the presence of a communication unit, which is connected downstream of the control unit 20, and transmits information determined by the control unit 20 regarding delayed or missing locking of the electric locking unit 10 to an external server. In this way, the information relating to the locking function of the electric locking unit 10 can be easily transmitted to the manufacturer so that servicing work, maintenance and/or repair measures can be planned externally without the operating personnel having to do this on site.

In the embodiment of the electric locking unit 10 which is represented in FIGS. 1 to 7b, it indicates the presence of a door sensor 4 in the form of a mechanical sensor pin, which signals the status of the door. However, such a door sensor 4 is optional.

When the door is closed, then the sensor pin contacts the door through a contact opening 41 in the locking part 3, a spring acting on the sensor pin is pressed in and signals the closed condition of the door by actuating a contact on the circuit board.

If the door is opened, then the contact between the door and the sensor pin will be interrupted, the spring will be subsequently released and the sensor pin signals that the door is open. In this way, unauthorized opening of the door or breaking it open can be detected and a signal, such as an alarm, can be emitted.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. A method for monitoring the locking mechanism of an electric locking unit, comprising the steps of:
providing the electric locking unit with a locking bolt configured to be inserted into a recess of a locking part;
reversibly adjusting the locking bolt from an open position to a closed position during a closing operation;
wherein the locking bolt extends from the recess of the locking part in the open position; and
wherein the locking bolt projects into the recess of the locking part in the closed position, wherein a locking mechanism can be produced;
determining a closing time span of the locking bolt, wherein the closing time span of the locking bolt comprises an amount of time that the locking bolt requires to transition from the open position to the closed position during the closing process;
comparing the determined closing time span of the locking bolt with a predetermined closing time span limit value; and
detecting delayed locking of the electric locking unit when the determined closing time span exceeds the predetermined closing time span limit value.

2. The method according to claim 1, wherein:
the step of determining the closing time span further comprises at least one of:
monitoring the open position and the closed position of the locking bolt, whereby points in time at which the locking bolt assumes the open position and the times at which the locking bolt assumes the closed position are determined;
predetermining a closing time span maximum value that indicates a maximum time span for reaching the closed position of the locking bolt after reaching the open position of the locking bolt, has been determined; and
wherein the step of detecting delayed locking of the electric locking unit further comprises determining when a period of time which has elapsed since the locking bolt assumed the open position has exceeded the closing time span maximum value before the locking bolt assumes the closed position.

3. The method according to claim 1, further comprising the step of determining a closing speed of the locking bolt as a function of:
a determined times at which the locking bolt assumes the open position;
a determined times at which the locking bolt assumes the closed position; and
a known distance path covered by the locking bolt between the open and closed position.

4. The method according to claim 1, further comprising the steps of:
inserting the locking part of the electric locking unit a closing recess of the electric locking unit and into an adjustment path of the locking bolt during the closing process;
during the closing process, introducing the locking part is into the closing recess and subsequently striking the locking bolt, so that the locking bolt is moved against a spring force of a spring and the spring is tensioned and the locking bolt is displaced into the open position and clears the way for the locking part into the closing recess; and
as the recess of the locking part comes into the adjustment path of the locking bolt, extending the locking bolt by the spring force of the spring and pressing the locking bolt into the recess of the locking part and thereby being held in the closed position, so that the locking bolt engages in the recess and blocks the locking part from exiting the closing recess.

5. A locking system with monitoring of the locking in an electric locking unit, comprising:
an electric locking unit comprising a locking bolt which can be inserted into a recess of a locking part, wherein the locking bolt is configured to be reversibly adjusted from an open position to a closed position during a closing operation, wherein the locking bolt is extended from the recess of the locking part in the open position and projects into the recess of the locking part in the closed position, whereby a locking mechanism can therefore be created; and
a control unit connected with the electric locking unit and configured to execute the method according to one claim 1.

6. The locking system according to claim 5, further comprising:
a first electrical switch configured to monitor the open position, wherein the first electrical switch is interrupted in its initial state, an electrically conductive connection thereby being established, and the first electrical switch being closed when the locking bolt assumes the open position;
a second electrical switch configured to monitor the closed position, wherein the second electrical swtich is interrupted in its initial state, an electrically conductive connection thereby being established, and the second electrical switch being closed when the locking bolt assumes the closed position;
whereby the first and second electrical switches are connected with the control unit and wherein the control unit is is configured to respectively determine:
those points in time at which the first electrical switch is closed at the open position as those points in time at which the locking bolt assumes the open position; and
those points in time at which the second electrical switch is closed in the closed position as those points in time at which the locking bolt assumes the closed position.

7. The locking system according to claim 6, wherein the first electrical switch and the second electrical switch are both respectively created by an open pair of electrodes, and wherein current flows between the two electrodes of the open pair of electrodes when the locking bolt assumes the open position and when the locking bolt assumes the closed position, repectively.

8. The locking system according to claim 5, wherein the electric locking unit further comprises:
a first mechanically actuable switch for monitoring the open position, the first mechanically actuable switch configured to be actuated when the locking bolt is moved into the open position, in particular by a control pin which is arranged on the locking bolt; and
a second mechanically actuable switch for monitoring the closed position, the second mechanically actuable switch configured to be actuated when the locking bolt is moved into the closed position, in particular by the control pin of the locking bolt;
whereby the first and second mechanically operable switches are connected with the control unit and wherein the control unit is configured to respectively determine:
points in time of actuation of the first mechanically actuable switch at the open position as those points in time at which the locking bolt assumes the open position; and
points in time of actuation of the second mechanically actuable switch at the closed position as those points in time at which the locking bolt assumes the closed position.

9. The locking system according to claim 5, wherein a closing time span maximum value is stored in the control unit, the closing time span maximum value indicating the maximum time span for reaching the closed position of the locking bolt after reaching the open position of the locking bolt; and
wherein the control unit is configured to detect a lack of locking of the electric locking unit when a period of time since the locking bolt assumed the open position exceeds the closing time span maximum value before the locking bolt assumes the closed position.

10. The locking system according to claim 5, wherein the control unit is configured to emit a warning signal when either a delayed locking of the electric locking unit is detected or a missing locking of the electric locking unit is detected.

11. The locking system according to claim 5, wherein the locking system comprises a communication unit connected downstream of the control unit and configured to transmit information from the control unit to a server.

12. The locking system according to claim 5, wherein the electric locking unit further comprises a closing recess wherein the locking part is configured to be inserted into the closing recess and into an adjustment path of the locking bolt during the closing operation;
wherein, during the closing operation, the locking part is inserted into closing recess, thereby striking the locking bolt to move the locking bolt against a spring force of a spring, thereby tensioning the spring, and disiplacing the locking bolt into the open position and allowing the locking part into the closing recess; and
whrein, as the recess of the locking part comes into the adjustment path of the locking bolt, the locking bolt is exxtended by the spring force of the spring and pressed into the recess of the locking part and retained in the closed position, wherein the locking bolt engages in the recess and blocks the locking part from exiting the closing recess.

13. An electric locking unit for a locking system according to claim 5, comprising:
a first electrical switch configured to monitor the open position, wherein the first electrical switch is interrupted in its initial state, an electrically conductive connection thereby being established, and the first electrical switch being closed when the locking bolt assumes the open position;
a second electrical switch configured to monitor the closed position, wherein the second electrical switch is interrupted in its initial state, an electrically conductive connection thereby being established, and the second electrical switch being closed when the locking bolt assumes the closed position; and
wherein the first and second electrical switches are connected with the control unit and wherein the control unit is configured to respectively determine:
points in time at which the first electrical switch is closed at the open position as those points in time at which the locking bolt assumes the open position; and
points in time at which the second electrical switch is closed in the closed position as those points in time at which the locking bolt assumes the closed position.

14. The electrical locking unit according to claim 13, wherein the first electrical switch and the second electrical switch are each formed by an open pair of electrodes, wherein current flows between the two electrodes of the open pair of electrodes when the locking bolt assumes the open position and when the locking bolt assumes the closed position, respectively.

15. An electric locking unit for a locking system according to claim 5, comprising:
a first mechanically actuable switch for monitoring the open position, the first mechanically actuable switch being configured to be actuated when the locking bolt is moved into the open position;
a second mechanically actuable switch for monitoring the closed position, the second mechanically actuable switch configured to be actuated when the locking bolt is moved into the closed position; and
wherein the first and second mechanically operable switches are connected with the control unit and wherein the control unit is configured to respectively determine:
points in time of actuation of the first mechanically actuable switch at the open position as those points in time at which the locking bolt assumes the open position; and
times of actuation of the second mechanically actuable switch at the closed position as those points in time at which the locking bolt assumes the closed position.

16. A cabinet having at least one door and an interior space delimited by the door, comprising an electrical locking unit according to claim 13, wherein the electrical locking unit is configured in the interior space of the cabinet and the locking part is configured on the door of the cabinet, the locking part being extended from the electrical locking unit in an open state of the electrical locking unit and the door being openable.

17. The electric locking unit for a locking system according to claim 15, wherein each of the first and second mechanically actuable switches is further configured to emit a corresponding electrical signal when actuated.
